(19) United States
(12) Patent Application Publication
(10) Pub. No.: US 2007/0021909 A1
(43) Pub. Date: Jan. 25, 2007

(54) Navigation system

(75) Inventor: Naoki Matsuda, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/483,524

(22) Filed: Jul. 11, 2006

(30) Foreign Application Priority Data
Jul. 21, 2005 (JP) 2005-211382

(51) Int. Cl. G01C 21/00

(52) U.S. Cl. 701/208; 701/200; 701/211

(57) ABSTRACT

A current position is detected. Representative routes from a current position are extracted from map data. With respect to each extracted route, road information and congestion information are retrieved. An expected mileage is calculated with respect to each route based on (i) the retrieved information and (ii) a relationship between a road attribute and a mileage, which is stored in an external memory device. A possible travel distance is then calculated with respect to each route using a remaining fuel amount. A route portion corresponding to each calculated possible travel distance with respect to each route is displayed on a map with a display color of the route portion changed.

### CROSS REFERENCE TO RELATED APPLICATIONS

This application is based on and incorporates herein by reference Japanese Patent Application No. 2005-211382 filed on Jul. 21, 2005.

### FIELD OF THE INVENTION

The present invention relates to a navigation system, which displays a map of an area surrounding a subject vehicle to navigate.

### BACKGROUND OF THE INVENTION

A driver needs to consider a remaining fuel amount, which determines how far the vehicle continues to travel. Patent Document 1 discloses that a possible travel distance is calculated using a remaining fuel amount and a gas mileage; the calculated travel distance is shown on a map as a circle with a current position of the vehicle centered. This display method using a map allows the driver to easily understand the possible travel distance, compared with a method only using numeric characters. A point for replenishing fuel can be easily determined, which reduces a total travel time.

An actual travel distance depends on not only the remaining fuel amount, but also other factors such as vehicle speeds, accelerations, decelerations, or engine revolutions. For instance, it varies depending on types or congestion degrees of roads the vehicle travels. The calculation in Patent Document 1 does not consider a route, so it cannot accurately provide a possible travel distance.
Patent Document 1: JP-2000-131116A

### SUMMARY OF THE INVENTION

It is an object of the present invention to provide a navigation system to appropriately calculate a possible travel distance from a current position.

According to an aspect of the present invention, a navigation system for a vehicle is provided with the following. Position detecting means is included for detecting a current position of the vehicle. Map data storing means is included for storing map data including road attributes related to a fuel consumption of the vehicle. Mileage storing means is included for storing mileage information on a relationship between a travel state and a mileage. Fuel detecting means is included for detecting a remaining amount of fuel of the vehicle. Travel distance calculating means is included for (i) estimating a travel state based on a road attribute included in each of routes from the current position, (ii) calculating a fuel consumption amount by using the mileage information with respect to each of the routes, and (iii) calculating a possible travel distance from the current position with respect to each of the routes based on the detected remaining amount of fuel and the calculated fuel consumption amount. Displaying means is included for displaying the calculated possible travel distance, with respect to each of the routes, along with a map including the current position.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram illustrating an overall structure of a navigation system as an example according to an embodiment of the present invention;

FIG. 2 is a flow chart diagram illustrating a process of calculating and displaying a possible travel distance with a route not designated;

FIG. 3 is a diagram illustrating possible travel distances on a map while differentiating display forms of the possible travel distances;

FIG. 4 is a flow chart diagram illustrating a process of calculating and displaying a possible travel distance with a route designated;

FIG. 5A is a diagram illustrating possible travel distances in candidate routes on a map while differentiating display forms of the possible travel distances;

FIG. 5B is a diagram illustrating a possible travel distance in a guide route on a map while differentiating a display form of the possible travel distance; and

FIG. 6 is a diagram illustrating possible travel distances on a map while differentiating between display forms of the possible travel distances.

### DETAILED DESCRIPTION OF THE PREFERRED EMBODIMENTS

A navigation system 100, provided in a vehicle, as an example according to an embodiment of the present invention will be explained.

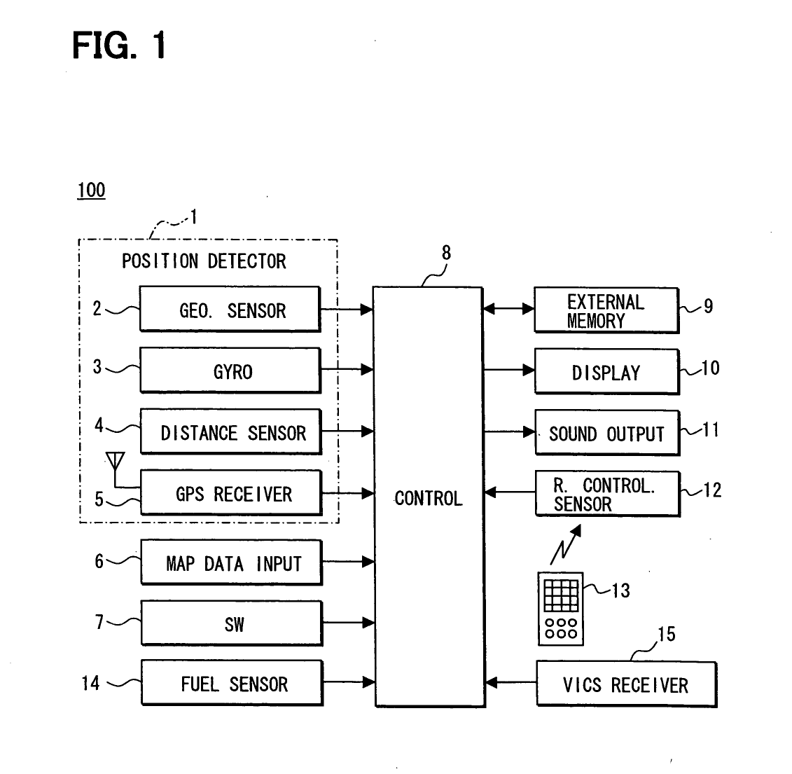

As shown in FIG. 1, the navigation system 100 includes a position detector 1, map data input device 6, operation switch group 7, external memory device 9, display device 10, sound output device 11, remote controller sensor 12, remote controller 13, fuel sensor 14, VICS (Vehicle Information and Communication System) receiver 15, and a control circuit 8 connecting the foregoing.

The position detector 1 includes a geomagnetic sensor 2, gyroscope 3, distance sensor 4, and GPS (Global Positioning System) receiver 5 to detect a current position of the vehicle based on received radio waves from GPS satellites. The sensors 2 to 5 are used in a complementary style, since they include different types of detection errors. The position detector 1 may only include some of the sensors 2 to 5. The position detector 1 may further include a steering rotation sensor or a speed sensor for each following wheel. The detected current position is used in a route guide to determine whether the vehicle travels along a guide route or where the vehicle is in the guide route.

The map data input device 6 is used to input map data to the control circuit 8. The map data includes road map data indicating connections of roads, background data such as geographical data and facility data, and character data for displaying place names. The map data input device 6 includes a storage medium (or device) for storing the map data. The storage medium is typically a DVD-ROM or hard disk, which is suitable for a data volume of the map data. Another storage medium such as a memory card may be alternatively used.

The road map data include node data and link data. The node data indicate a node at which roads intersect each other, merge with each other, or branch from each other. The link data indicate a link or road that connects nodes. The node data include a node ID, coordinates, name, link IDs connected, and intersection types, with respect to a node. The link data include a link ID, length, coordinates of start and end points, road types, width, travel time, and other data such as slope angle, with respect to a link.

The background data include geographical data and facility data while associating them with their coordinates on a map. The facility data are associated further with phone numbers and addresses. The character data include a place name, facility name, and road name, all of which are displayed on a map, while associating them with their coordinates on a map.

Thus the road map data together with the background data and character data are used in displaying a map including roads. The road map data are also used to provide a road shape for a map matching process, and to retrieve a guide route up to a destination.

The operation switch group 7 is touch switches or mechanical switches integrated with the display device 10. The switches are used to designate a start point or destination in route retrieval.

The external memory device 9 is a storage medium (or device) such as a memory card or hard disk to store various data including text data, image data, or sound data, which a user inputs.

The external memory device 9 further stores information on a mileage (or gas mileage) corresponding to each vehicular travel state. For instance, the information includes a base mileage indicated in a catalogue, and various relationships with mileage as ratios to the base mileage. The relationships are between a regulation speed and mileage, between a slope angle and mileage, between the number of lanes and mileage, between presence/absence of a traffic signal and a mileage, and between a road attribute and mileage. For instance, a different regulation speed causes a vehicle to travel at a different speed, resulting in a different mileage. A vehicle travels on a road with multiple lanes more smoothly than a single-lane road, decreasing accelerations and decelerations and resulting in a lower mileage. A vehicle needs more driving power in traveling at a fixed speed on a road with a steeper ascending slope, resulting in a lower mileage. A temporary stop or turn at an intersection causes a vehicle to need an additional engine start to consume more fuel. These factors are used to determine each corresponding ratio to the base mileage. Furthermore, the mileage information may be a relationship directly based on a vehicular travel state such as between a certain fixed speed and mileage, or between an acceleration/deceleration and mileage.

The display device 10 includes, e.g., a liquid crystal display. The screen of the display device 10 displays a vehicle position mark corresponding to a current position of the vehicle, and a road map around the vehicle generated by a map database inputted from the map data input device 6. According to an instruction via the operation switch group 7, the display device 10 displays various windows such as a menu window or a setting window. Furthermore, the display device 10 displays a given portion, which corresponds to a possible travel distance in a representative route from a current position, by using a different color.

The sound output device 11 includes a speaker and audio amplifier to perform a voice guide in navigating.

The remote controller 13 and remote controller sensor 12 can be used equivalently to the operation switch group 7 as input means to perform various instructions for the navigation system 100.

The fuel sensor 14 outputs an electrical signal corresponding to a remaining fuel amount in a fuel tank to inform the control circuit 8 of the remaining fuel amount for calculating a possible travel distance.

The VICS receiver 15 is an example of a wireless device to communicate with an outside of the vehicle and obtain road traffic information. The VICS receiver 15 receives road traffic information from the VICS center via beacons laid under roads or via an FM broadcast station. The road traffic information includes road congestion information and traffic regulation information on blocked roads due to an accident or construction or on closure of expressway gates. The congestion information is used for the control circuit 8 to estimate a mileage in calculating a possible travel distance.

The control circuit 8 includes a known computer to have a CPU, ROM, RAM, I/O, and bus line connecting the foregoing components. The ROM includes a program for the control circuit 8 or CPU to execute various processing using other components. For instance, with a start point and destination designated by a user or driver, the control circuit 8 retrieves several candidate routes from the start point to the destination using the map data. The control circuit 8 navigates the vehicle along one of the candidate routes that is designated by the user. Even with no route designated, the control circuit 8 performs a map matching process, which matches a current position detected based on a signal from the position detector 1 and a road on a map with each other.

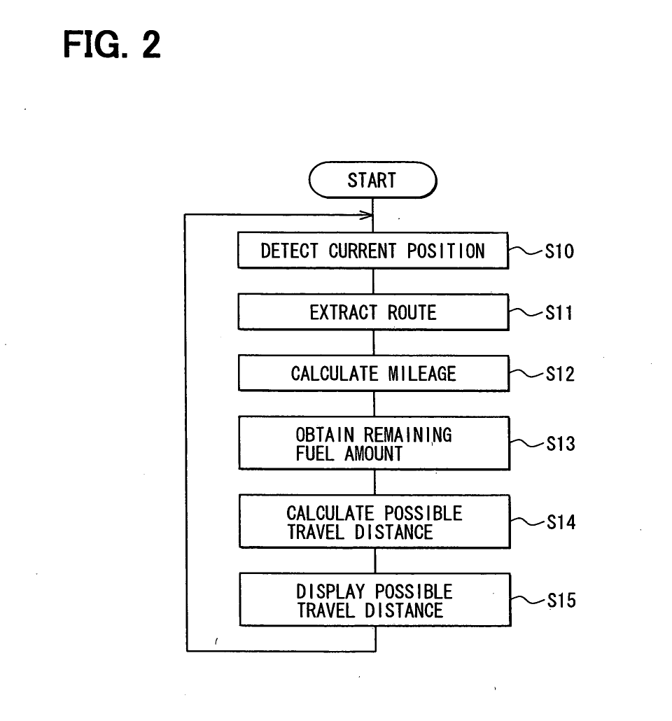

Furthermore, the control circuit 8 calculates a possible travel distance with respect to a representative route from a current position, and displays a route portion corresponding to the calculated possible travel distance in a color that is different from the other route portion. This process takes place according to a flow chart in FIG. 2, with no route designated.

At Step S10, a current position is detected using the position detector 1. At Step S11, a representative route is extracted from the map data for calculating a possible travel distance. For instance, the representative route includes a road that has a width larger than a given width and starts from the current position. Even if the driver takes a certain route other than the extracted route, the driver can estimate a possible travel distance in the certain route by referring to the differentiated possible travel distance in the extracted route close to the certain route.

At Step S12, a fuel mileage (or mileage) is estimated with respect to each of extracted routes. For instance, the control circuit 8 refers to road information on nodes and links included in each extracted route; the road information includes regulation speeds, the number of lanes, slope angles, and presence/absence of traffic signals and/or intersections. For instance, road information such as a regulation speed X km/hour, the number of lanes Y, slope angle Z degrees, and the number of traffic signals W are retrieved with respect to a certain section. Using the retrieved road information, an expected mileage with respect to the certain section is estimated based on a relationship between a road attribute and mileage stored in the external memory device 9. Furthermore, congestion information via the VICS receiver 15 may be also considered. The received congestion information causes an expected vehicle speed to decrease than a corresponding regulation speed. The resultant decreased speed is then used for calculating an expected mileage.

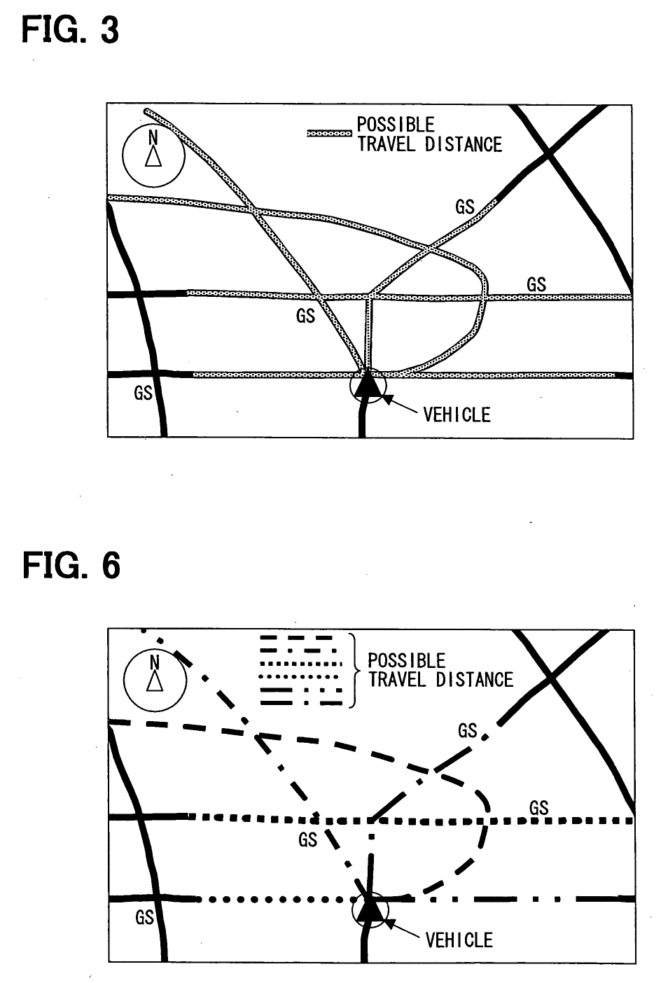

At Step S13, the control circuit 8 obtains a remaining fuel amount via the fuel sensor 14. At Step S14, a possible travel distance with respect to each of the extracted routes is calculated based on the obtained remaining fuel amount and the expected mileage. At Step S15, a route portion corresponding to the calculated possible travel distance from the current position with respect to each of the extracted routes is changed in its display color (e.g., changed to red) on a map surrounding the vehicle. In FIG. 3, the route portion corresponding to the calculated possible travel distance is shown as a shaded line for explanation. The route portion corresponding to the calculated possible travel distance may be also numerically displayed on the map. A point (GS) for supplying or replenishing fuel is simultaneously displayed, as shown in FIG. 3. This enables the driver to easily understand the possible travel distance with respect to each route and determine whether the remaining fuel is sufficient for traveling to a destination. Displaying the point for supplying fuel on the map allows the driver to plan to replenish the fuel at an appropriate point.

Then the process returns to Step S10 to repeat Steps S10 to S15. Thus, during the driving, the possible travel distance in the representative route is constantly displayed from the current position; the possible travel distance is calculated based on the current remaining fuel amount and congestion degree in each route. This allows the driver to drive the vehicle without anxiety that the vehicle runs out of fuel during the driving.

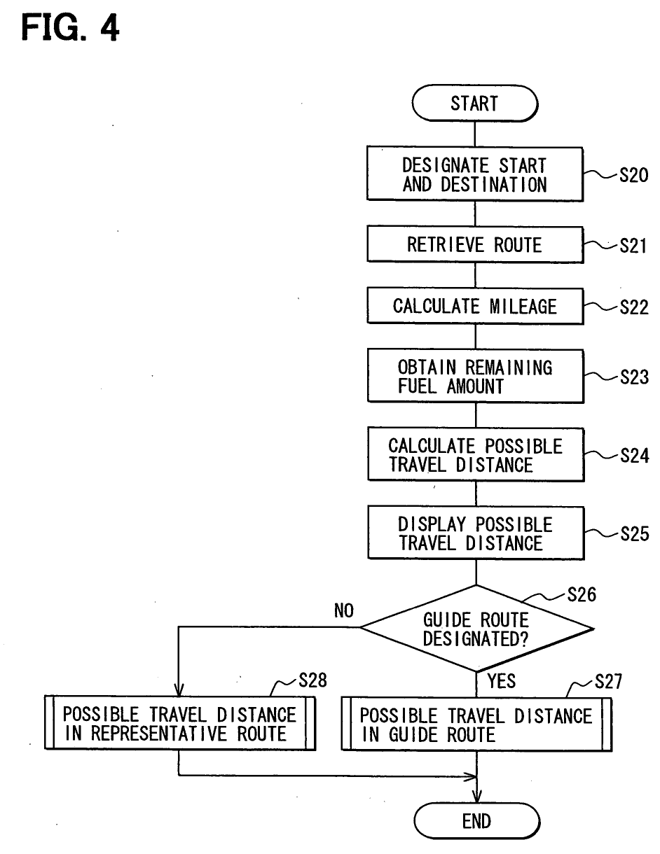

Next, a process, which displays a possible travel distance with a route designated, will be explained with reference to a flow chart in FIG. 4.

At Step S20, a driver or user designates a start point and destination. At Step 21, the control circuit 8 searches for several optimum routes from the start point to the destination under several conditions. For instance, they include the shortest route, the fastest route, or a route without toll roads. The control circuit 8 calculates a path cost, which indicates easiness in passing through each node or each link constituting road map data. The path cost is calculated based on (i) characteristics (link length, road type, road width, etc.) and (ii) types of direct advance and right/left turn, with respect to each link or each node. Path costs are summed up with respect to links and nodes included in each route from the start point to the destination. A route having the minimum cost under a certain condition is retrieved with a route retrieval method such as the Dijkstra method.

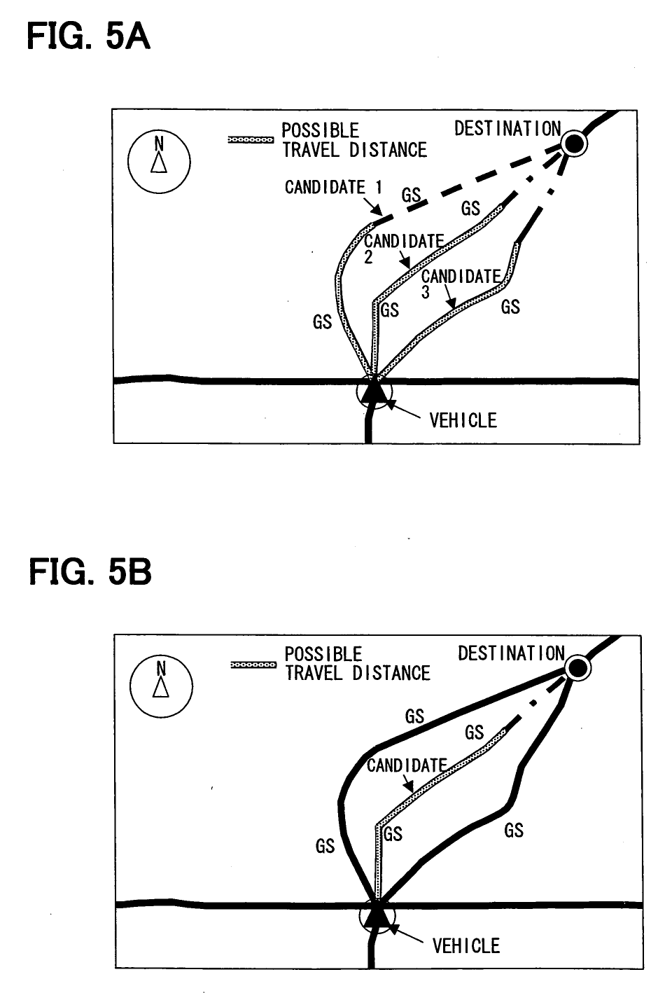

At Step S22, an expected mileage is calculated with respect to each retrieved candidate routes by using the same method as at Step S12 in FIG. 2. Similarly to Steps S13, S14 in FIG. 2, at Steps S23, S24, respectively, a remaining fuel amount is obtained and a possible travel distance is calculated, with respect to each route. At Step S25, retrieved candidate routes are displayed on the screen of the display device 10, and each route portion corresponding to the possible travel distance is displayed while its color is changed (e.g., changed to red) from other route portions. In FIG. 5A, three candidate routes are shown while each route portion corresponding to the possible travel distance is shown in a shaded line for explanation. A point (GS) for supplying fuel is simultaneously displayed. This enables the driver to easily understand which candidate route can reach a point nearest to the destination with the current remaining fuel amount. Thus, the driver can select one of the candidate routes by referring to the displayed possible travel distances and plan to replenish the fuel at an appropriate point.

At Step S26, it is determined whether the driver designates a guide route. When the driver designates a guide route, e.g., from three candidate routes in FIG. 5A, Step S27 is performed. At Step S27, the control circuit 8 executes a process to change to display, only with respect to the designated route, the route portion corresponding to the possible travel distance in the different color (e.g., red). Referring to FIG. 5B, the candidate route 1 is designated as the guide route from the three candidate routes 1 to 3 and only its route portion corresponding to the possible travel distance is shown in the shaded line for explanation. Having designated the guide route indicates that the vehicle is assumed to travel along the guide route. Therefore, possible travel distances in other routes need not be emphasized.

In contrast, when the driver does not designate a guide route, Step S28 is performed. At Step S28, the control circuit 8 executes a process to change to display, with respect to representative routes, the route portions corresponding to the possible travel distances in the different color as shown in FIG. 3.

As explained above, when the vehicle travels with no route designated, the control circuit 8 repeatedly calculates a possible travel distance in each of representative routes from a current position while displaying route portions corresponding to the calculated possible travel distances in a color different from other route portions on a map. Points for supplying fuel are simultaneously displayed on the map. The possible travel distance is assumed to be accurate since it is calculated based on characteristics and congestion degrees of each route. This enables a driver to easily understand whether fuel replenishment is necessary before reaching a destination and to plan where to replenish fuel.

In contrast, when a route is set or when a start point and destination is designated, the control circuit 8 displays possible travel distances in several retrieved candidate routes on a map. This allows a driver to refer to the displayed possible travel distances in the retrieved routes before designating a guide route. After a guide route is designated, the control circuit 8 changes to display only a possible travel distance in the designated guide route. This is because the subject vehicle is assumed to not travel on any routes other than the designated guide route.

(Modifications)

In the above, route portions corresponding to possible travel distances in routes are displayed in an identical color, which is different from a color of other route portions in the routes or other routes, as shown in FIG. 3. The corresponding routes may intricately intersect each other. This makes it difficult to understand which route corresponds to which possible travel distance. The possible travel distances may be differentiated from each other by using different colors. In other word, each of the possible travel distances has a unique color. Furthermore, possible travel distances are displayed by the individually different types of lines, e.g., broken line, chain line, chain double-dashed line, dotted line, or the like, as shown in FIG. 6.

The representative route, in which a possible travel distance is emphatically displayed, includes a road that has a width larger than a given width and advances in the heading direction of the vehicle. It is because the vehicle may travel on this representative route with a high possibility. However, another route can be a representative route depending on a purpose. For instance, a representative route can be selected based on the number of lanes, or a certain road type (e.g., national road or prefectural road). Furthermore, it can be designed that a user can determine how to select a representative route. For instance, a user can select a representative route that includes only national roads by inputting a national road as a road type preferable for a representative route.

In the above, a mileage is calculated based on travel-state-specific mileage information stored in the external memory device 9. A mileage even in the same route may be different between drivers. A first driver suddenly starts or accelerates a vehicle, while a second driver slowly starts or accelerates a vehicle. The base mileage stored in the external memory device 9 may be adjustable. A driver may adjust the base mileage by himself. The base mileage can be adjusted to follow an average mileage obtained from a resultant relationship between a fuel consumption and a travel distance. When the base mileage is adjusted, a travel-state-specific mileage indicated as a ratio to the base mileage is automatically adjusted. This does not increase a burden on a driver. The possible travel distance can be calculated by reflecting driver's tendency.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A navigation system for a vehicle, the system comprising:
position detecting means for detecting a current position of the vehicle;
map data storing means for storing map data including road attributes related to a fuel consumption of the vehicle;
mileage storing means for storing mileage information on a relationship between a travel state and a mileage;
fuel detecting means for detecting a remaining amount of fuel of the vehicle;
travel distance calculating means for
estimating a travel state based on a road attribute included in each of routes from the current position,
calculating a fuel consumption amount by using the mileage information with respect to each of the routes, and
calculating a possible travel distance from the current position with respect to each of the routes based on the detected remaining amount of fuel and the calculated fuel consumption amount; and
displaying means for displaying the calculated possible travel distance, with respect to each of the routes, along with a map including the current position.

2. The navigation system of claim 1, further comprising:
congestion information obtaining means for obtaining congestion information, wherein
the travel distance calculating means estimates the travel state further based on the obtained congestion information.

3. The navigation system of claim 1, wherein
with respect to the routes, first route portions corresponding to the calculated possible travel distances are displayed in first display forms different from second display forms, in which second route portions that exclude the first route portions are displayed.

4. The navigation system of claim 3, wherein
the first display forms are different from each other.

5. The navigation system of claim 1, wherein
the displaying means displays a point where fuel is to be replenished to the vehicle.

6. The navigation system of claim 1, wherein
the travel distance calculating means calculates a possible travel distance with respect to each of the routes, each of which is included in a given route.

7. The navigation system of claim 6, wherein
the given route includes a road having a road width wider than a given width.

8. The navigation system of claim 6, wherein
the given route departs from the current position.

9. The navigation system of claim 6, further comprising:
heading direction detection means for detecting a heading direction of the vehicle, wherein
the given route advances in the heading direction.

10. The navigation system of claim 6, further comprising:
designation means for designating a start point and a destination; and
retrieval means for retrieving a route from the start point to the destination, wherein
the retrieved route is included in the given route.

11. The navigation system of claim 10, further comprising:
single route designating means for designating a single route from routes retrieved by the retrieval means, wherein
the travel distance calculating means then calculates a possible travel distance with respect to only the designated single route.

12. The navigation system of claim 1, further comprising:
adjusting means for adjusting a base mileage, which indicates a mileage in a base travel state, wherein
the mileage information includes the base mileage and a ratio of a mileage with respect to each travel state to the base mileage.

13. A method used for a navigation system for a vehicle, the system including:
a position detector that is used to detect a current position of the vehicle;
a map data storage device that stores map data including road attributes related to a fuel consumption of the vehicle;
a display device that is used to display a map based on the map data;
a mileage storage device that stores mileage information on a relationship between a travel state and a mileage; and
a fuel sensor that is used to detect a remaining amount of fuel of the vehicle,
the method comprising:
estimating a travel state based on a road attribute included in each of routes from the current position;
calculating a fuel consumption amount by using the mileage information with respect to each of the routes;
calculating a possible travel distance from the current position with respect to each of the routes based on the detected remaining amount of fuel and the calculated fuel consumption amount; and
causing the display device to display the calculated possible travel distance, with respect to each of the routes, along with a map including the current position.

14. A navigation system for a vehicle, the system comprising:
a position detector that is used to detect a current position of the vehicle;
a map data storage device that stores map data including road attributes related to a fuel consumption of the vehicle;
a display device that is used to display a map based on the map data;
a mileage storage device that stores mileage information on a relationship between a travel state and a mileage;
a fuel sensor that is used to detect a remaining amount of fuel of the vehicle; and
a control circuit that
estimates a travel state based on a road attribute included in each of routes from the current position,
calculates a fuel consumption amount by using the mileage information with respect to each of the routes,
calculates a possible travel distance from the current position with respect to each of the routes based on the detected remaining amount of fuel and the calculated fuel consumption amount, and
causes the display device to display the calculated possible travel distance, with respect to each of the routes, along with a map including the current position.
